(19) United States
(12) Patent Application Publication
(10) Pub. No.: US 2010/0225636 A1
(43) Pub. Date: Sep. 9, 2010

(54) DISPLAY DEVICE AND DISPLAY METHOD THEREOF

(75) Inventors: LI-ZHANG HUANG, Tu-Cheng (TW); CHUAN-HONG WANG, Tu-Cheng (TW); XIAO-GUANG LI, Shenzhen City (CN); KUAN-HONG HSIEH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/558,591

(22) Filed: Sep. 14, 2009

(30) Foreign Application Priority Data
Mar. 7, 2009 (CN) 200910300745.9

(51) Int. Cl. G06F 3/038

(52) U.S. Cl. 345/213

(57) ABSTRACT

This present disclosure provides a display device and method thereof. The display method used in a display device, the display device includes a display unit, a clock unit, a storage unit and an analog clock implementation module, the clock unit configured to provide current real time, and the storage unit configured to store display contents and display modes of an analog clock. The method includes determining positions of clock markings using the analog clock implementation module for the analog clock around the display unit; acquiring the display mode of the analog clock; displaying the current time in the analog clock, acquiring and displaying display contents together with the analog clock in the display mode.

### BACKGROUND

1. Technical Field

The present disclosure relates to a display device and a display method thereof.

2. Description of Related Art

Generally, a display device, such as a digital photo frame, or others, displays a current time in a character type or analog clock manner. Little variety, however, is available to customize the display, and very often, the normal display function of the device is interfered with by the customization.

### BRIEF DESCRIPTION OF THE DRAWINGS

The components in the drawings are not necessarily drawn to scale, the emphasis instead being placed upon clearly illustrating the principles of the display device. Moreover, in the drawings, like reference numerals designate corresponding parts throughout the several views.

FIG. 1 is a block diagram of a hardware infrastructure of a display device, in accordance with an exemplary embodiment.

FIG. 2 is a schematic diagram of an analog clock displayed in a first display mode on the display device of FIG. 1.

FIG. 3 is a schematic diagram of an analog clock displayed in a second display mode on the display device of FIG. 1.

FIG. 4 is a flowchart of a display method implemented on the display device, such as, for example, that of FIG. 1, in accordance with an exemplary embodiment.

FIG. 5 is a flowchart of displaying an analog clock in a first display mode as part of the method of FIG. 4.

FIG. 6 is a flowchart of displaying an analog clock in a second display mode as part of the method of FIG. 4.

### DETAILED DESCRIPTION

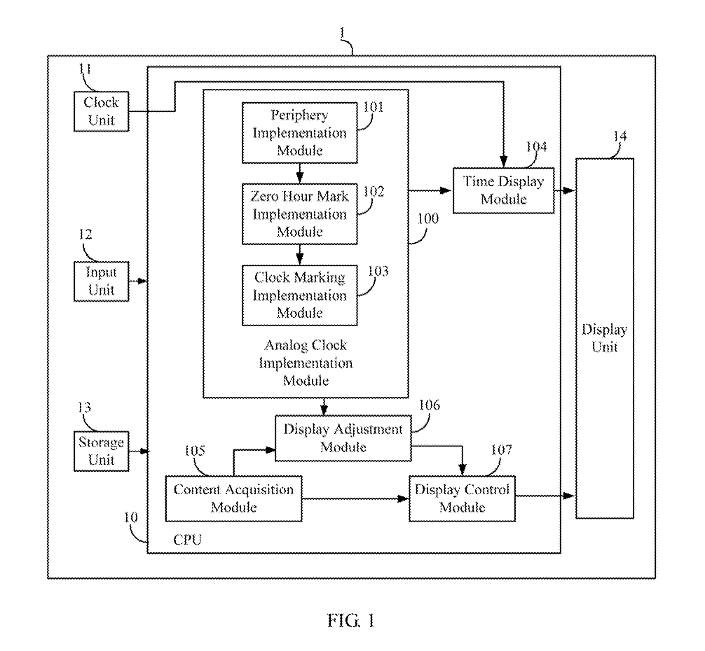

FIG. 1 is a block diagram of a hardware infrastructure of a display device, in accordance with an exemplary embodiment. The display device 1 may be, but is not limited to, a digital photo frame (DPF), or a TV set. The display device 1 is capable of effectively displaying an analog clock without affecting normal function of the display device 1.

In an exemplary embodiment, the display device 1 includes a central processing unit (CPU) 10, a clock unit 11, an input unit 12, a storage unit 13, and a display unit 14.

The clock unit 11 is configured to provide current real time. The input unit 12 is configured to generate signals in response to user inputs. In the exemplary embodiment, the input unit 12 generates a display mode selection signal in response to manual selection of a display mode.

The storage unit 13 is configured to store display contents (such as pictures, text, and others), predetermined attribute information for the analog clock displayed on the display unit 14, and display modes for displaying the analog clock on the display unit 14. The attribute information for the analog clock includes, but is not limited to, shape, size, color of hour, minute and second hands, clock marking and others. In the exemplary embodiment, the display modes include, but are not limited to, a first display mode and a second display mode. In the first display mode, the analog clock is displayed as a translucent layer and overlying the regular display contents. In the second display mode, the analog clock is displayed around the periphery of the regular display contents.

The CPU 10 includes an analog clock implementation module 100, a time display module 104, a content acquisition module 105, and a display control module 107.

The analog clock implementation module 100 is configured to generate an analog clock on a periphery of the display unit 14. The shape of the periphery is square or round. The generated analog clock displays minute, hour, and other appropriate markings. The time display module 104 is configured to acquire current time from the clock unit 11 and display the elements correspondingly on the analog clock according to the current time. The content acquisition module 105 is configured to acquire the display contents from the storage unit 13. The display control module 107 is configured to display the analog clock together with the acquired display contents in one of the display modes.

The analog clock implementation module 100 includes a periphery implementation module 101, a zero hour mark implementation module 102, and a clock marking implementation module 103.

The periphery implementation module 101 is configured to generate a virtual periphery on the display unit 14, wherein the center of the virtual periphery conforms to the that of the display unit 14. The periphery is virtual and could not displayed on the display unit 14. The zero hour mark implementation module 102 is configured to generate a position of a zero hour mark (i.e., the 12 o'clock mark) on the virtual periphery, and the attribute information of the zero hour mark. In this exemplary embodiment, the zero hour mark implementation module 102 takes an intersection point of an upper side of the virtual periphery and a symmetrical vertical axis of the virtual periphery as the position of the zero mark. The clock marking implementation module 103 is configured to determine positions and attribute information of clock markings other than the zero hour mark on the virtual periphery.

During determination of the positions of the other clock markings, the clock marking implementation module 103 uses the center of the display unit 14 as a center of the analog clock dial, uses a virtual line with one end at the center point of the analog clock and through the zero hour mark, and rotates the line around the center point in a series of predetermined angles, each determining the position of a clock marking. Repeating the process, the clock marking implementation module 103 determines the positions of all other clock markings. In detail, at every 30° around dial, the clock marking implementation module 103 sets a position for an hour marking, and at every 6°, a minute marking.

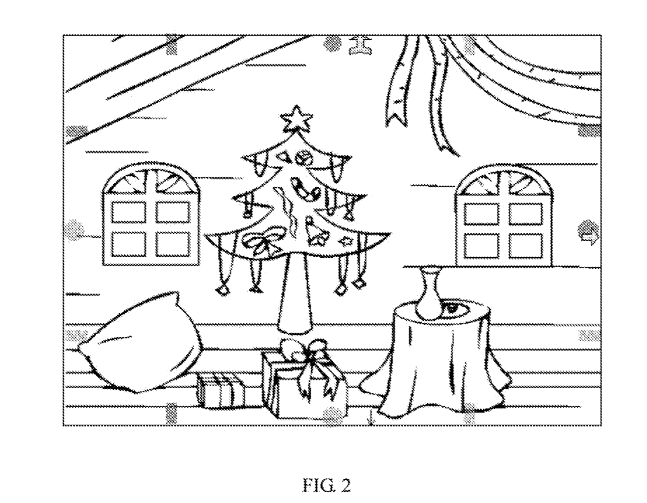

FIG. 2 is a schematic diagram of an analog clock displayed in a first display mode on the display device of FIG. 1. The display control module 107 displays the analog clock in a translucent manner, overlying the display contents, as shown in FIG. 2. Typically, the display control module 107 displays the analog clock as visible on the display unit 14, with the translucency of analog clock allowing detailed viewing of the display contents behind the analog clock. The analog clock is displayed as a translucent layer and overlying the display contents layer.

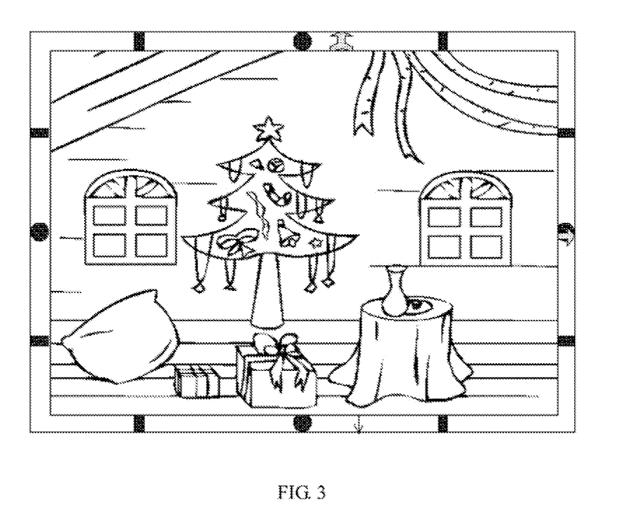

FIG. 3 is a schematic diagram of an analog clock displayed in a second display mode on the display device of FIG. 1. When the display device 1 is in the second display mode, the display device 1 further includes a display adjustment module 106. The display adjustment module 106 is configured to adjust the size of the display contents to match the margin area of the analog clock. Thus, after the content acquisition module 105 acquires the display contents, the display adjustment module 106 adjusts the display contents to be within the margin area of the analog clock, and then the display control module 107 displays the adjusted display contents on the display unit 14, as shown in FIG. 3.

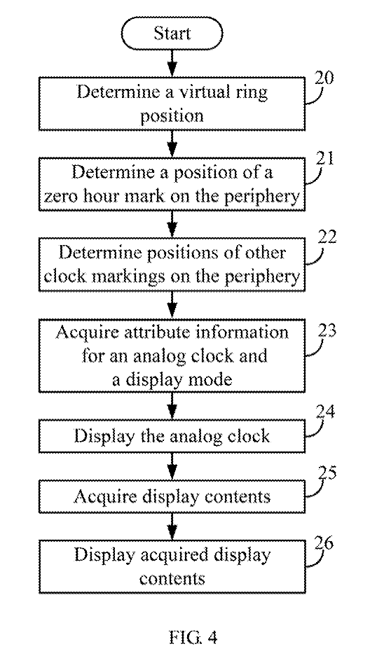

FIG. 4 is a flowchart of a display method implemented on a display device, such as, for example, that of FIG. 1, in accordance with an exemplary embodiment.

In step 20, the periphery implementation module 101 determines the virtual periphery of the analog clock. Typically, the periphery implementation module 101 determines the center of the display unit 14 as the center of the virtual periphery.

In step 21, the zero hour mark implementation module 102 determines the position of the zero hour mark on the virtual periphery.

In step 22, the clock marking implementation module 103 determines positions of clock markings other than the zero hour mark on the virtual periphery.

In step 23, the clock marking implementation module 103 acquires predetermined attribute information for the analog clock and a display mode from the storage unit 13.

In step 24, the time display module 104 acquires current time from the clock unit 11 and displays the hour, minute, and second hands in a corresponding position on the analog clock according to the current time.

In step 25, the content acquisition module 105 acquires display contents from the storage unit 13.

In step 26, the display control module 107 displays the analog clock together with the acquired display contents in one of the display modes.

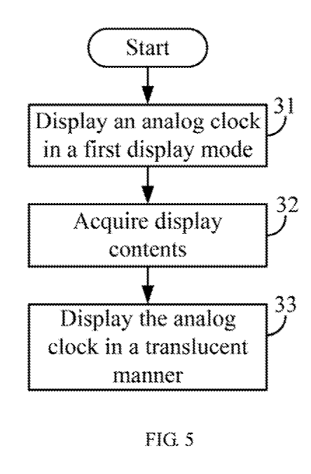

FIG. 5 is a flowchart of displaying an analog clock in the first display mode as part of the method of FIG. 4.

In step 31, the clock marking implementation module 103 acquires the first display mode from the storage unit 13 in response to a first display mode selection signal from the input unit 12.

In step 32, the content acquisition module 105 acquires the display contents from the storage unit 13.

In step 33, the display control module 107 displays the analog clock in a translucent manner on the display unit 14.

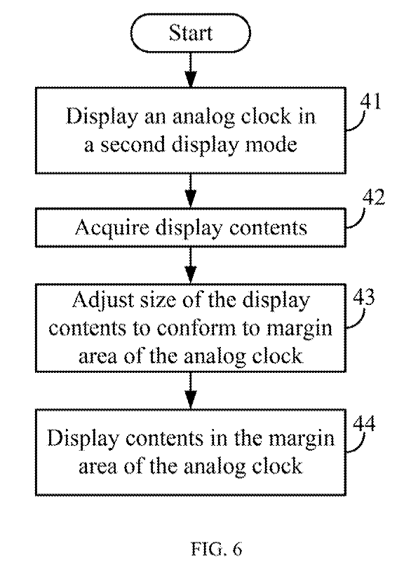

FIG. 6 is a flowchart of displaying an analog clock in the second display mode as part of the method of FIG. 4.

In step 41, the clock marking implementation module 103 acquires the second display mode from the storage unit 13 in response to a second display mode selection signal from the input unit 12.

In step 42, the content acquisition module 105 acquires the display contents from the storage unit 13.

In step 43, the display adjustment module 106 adjusts the size of the display contents to conform to the margin area of the analog clock.

In step 44, the display control module 107 displays the display contents in the margin area of the analog clock.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the disclosure.

What is claimed is:

1. A display device comprising:
a clock unit configured to provide current real time;
a storage unit configured to store display contents and display modes of an analog clock;
an input unit configured to generate a display mode selection signal in response to a manual selection of a display mode;
a display unit configured to display the display contents and the analog clock;
a content acquisition module configured to acquire display contents from the storage unit;
an analog clock implementation module configured to generate the analog clock in a periphery of the display unit;
a time display module configured to acquire the current time from the clock unit and display hour, minute, and second hands in corresponding positions on the analog clock face; and
a display control module configured to display the analog clock together with the acquired display contents in one of the display modes.

2. The display device as described in claim 1, wherein display modes comprise a first display mode, and the display control module displays the analog clock in the first display mode in a translucent manner overlying the display contents.

3. The display device as described in claim 1, further comprising a display adjustment module, configured to adjust the size of the display contents to conform to the margin area of the analog clock, wherein display modes comprise a second display mode, and the display control module displays the analog clock on the periphery of the display contents on the display unit in a second display mode.

4. The display device as described in claim 1, wherein the analog clock implementation module comprises a periphery implementation module, a zero hour mark implementation module and a clock marking implementation module, the periphery implementation module is configured to generate a virtual periphery on the display unit, the zero hour mark implementation module is configured to use an intersection point of an upper side of the virtual periphery and a symmetric vertical axis of the virtual periphery as the position of the zero hour mark, and the clock marking implementation module is configured to determine positions and attribute information of clock markings other than the zero hour mark on the virtual periphery.

5. The display device as described in claim 1, wherein the storage unit is further configured to store predetermined attribute information for the analog clock displayed on the display unit, and the attribute information for the analog clock comprises shape, size, color of hour, minute and second hands, clock marking.

6. A display method used in a display device, the display device comprising a display unit, a clock unit, a storage unit and an analog clock implementation module, the clock unit is configured to provide current real time, the storage unit configured to store display contents and display modes of an analog clock, the method comprising:
determining positions of clock markings using the analog clock implementation module for the analog clock around the display unit;
acquiring the display mode of the analog clock;
displaying the current time in the analog clock;
acquiring and displaying display contents together with the analog clock in the display mode.

7. The method as described in claim 6, wherein acquisition and display of display contents together with the analog clock in the display mode further comprises:
displaying the display contents in full-screen; and
displaying the analog clock overlying display contents in a translucent manner.

8. The method as described in claim 6, wherein acquiring and displaying display contents together with the analog clock in the display mode further comprises:
adjusting size of the display contents to conform to the margin area of the analog clock; and
displaying the adjusted display contents within the margin area of the analog clock.

9. The method as described in claim 6, wherein determination of positions of clock markings further comprises:
determining a virtual periphery position according to a center of the display unit;
determining the position of zero hour mark according to an intersection point an upper side of the virtual periphery and a vertical symmetrical axis of the virtual periphery;
determining the center of the display unit as a center of the analog clock face, using a virtual line with one end at the center point of the analog clock and through the zero hour mark, and rotating the virtual line by a predetermined angle each time, with each intersection point between the ray and the virtual periphery taken as the position of a clock marking.
